(19) United States
(12) Patent Application Publication
(10) Pub. No.: US 2014/0040181 A1
(43) Pub. Date: Feb. 6, 2014

(54) AUTOMATIC FAQ GENERATION

(71) Applicant: Vsevolod Kuznetsov, Sankt-Petersburg (RU)

(72) Inventor: Vsevolod Kuznetsov, Sankt-Petersburg (RU)

(73) Assignee: RAWLLIN INTERNATIONAL INC.

(21) Appl. No.: 13/563,642

(22) Filed: Jul. 31, 2012

(51) Int. Cl. G06N 5/02

(52) U.S. Cl. 706/55

(57) ABSTRACT

Generally described is auto generation of an FAQ based on partly textual content. A network service can receive at least partly textual content. A FAQ can be generated based on the content. Questions within the FAQ can be ranked based on popularity, usefulness, etc. When a question in the FAQ is selected, a link can be generated to the portions of the content where the question and answer were derived from.

### TECHNICAL FIELD

This application relates to content management, and more particularly to automatic generating of an FAQ based on at least partly textual content.

### BACKGROUND

The proliferation of Internet hosted content has been a boon to academia, businesses, and consumers alike. Opinions, research articles, books, photographs, and video are just some of the content available to be viewed both privately and publicly through the Internet. Along with the growth in available content, there has been a similar growth in the types of devices that can be used to access that content. Computers, tablets, e-readers, and smart phones are just some of the categories of devices available to consumers and businesses to access content.

As the type of devices that can access content has grown, the capabilities of the devices have become segmented. For example, devices can have a color screen or a black and white screen, devices can have varying resolutions, devices can have varying screen sizes, devices can have varying processing power, etc. The varying capabilities of devices can present challenges in the consumption of content. For example, the user of a device, such as a desktop computer with a large monitor, may desire to view a long detailed research article in its entirety. To the contrary, a user of a smart phone with a three inch screen with limited screen resolution may instead only desire to see a list of frequently asked questions (“FAQ”) regarding the detailed research article. While still other users may desire to review an FAQ instead of more detailed content no matter the capabilities of their devices.

While the original author or creator of the content can create an FAQ of the content, this relies on all authors to be good Samaritans to be useful on a grander scale. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to automatic annotation generation of a set of frequently asked questions (FAQs) for at least partly textual content. An input component can receive content, wherein the content is at least partly textual content. A semantic component, in response to reception of the content, can extract meaning from the content. An auto FAQ component can generate a set of FAQs based on the extracted meaning wherein the set of FAQs contains a set of questions and associated answers. An output component can send the FAQ to a content browser for display.

In another embodiment, at least partly textual content can be received. In response to receiving the content, meaning can be extracted from the content. A set of FAQs can be generated wherein the set of FAQs contains a set of questions and an associated set of answers. A question index can be sent to a content browser based on the set of FAQs. A rank can be generated and associated with questions of the question index based on at least one of a user selection, a user review, a user like or a user dislike. The question index can be sorted by the rank associated with questions of the question index.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1A illustrates example textual content;

FIG. 1B illustrates example content after a first stage of tokenization;

FIG. 2A illustrates example content after a second stage of tokenization;

FIG. 2B illustrates an example of parsing;

FIG. 2C illustrates an example of an auto-generated FAQ;

FIG. 3 illustrates an example high level flow diagram FAQ generation;

FIG. 4 illustrates an example network service;

FIG. 5 illustrates an example network service including components to extract meaning from the textual content;

FIG. 6 illustrates an example network service including a ranking component;

FIG. 7 illustrates an example network service including an answer link component;

FIG. 8 illustrates an example flow diagram method for auto generation of an FAQ;

FIG. 9 illustrates an example flow diagram method for auto generation of an FAQ further based on extracted meaning of the content;

FIG. 10 illustrates an example flow diagram method for auto generation of an FAQ including rankings;

FIG. 11 illustrates an example flow diagram method for auto generation of an FAQ including linking to content containing answers;

FIG. 12 illustrates an example block diagram of a computer operable to execute the disclosed architecture; and

FIG. 13 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein provide for auto generation of a FAQ for at least partly textual content. The system provides for automatically creating questions and answers relating to content where it was not previously available or explicitly provided. Content that is at least partly textual can be analyzed based on a combination of semantic features to determine key words, phrases, sentences, etc. to extract meaning from the content. It can be appreciated that through the extracted meaning, questions and answers can be generated that described the content.

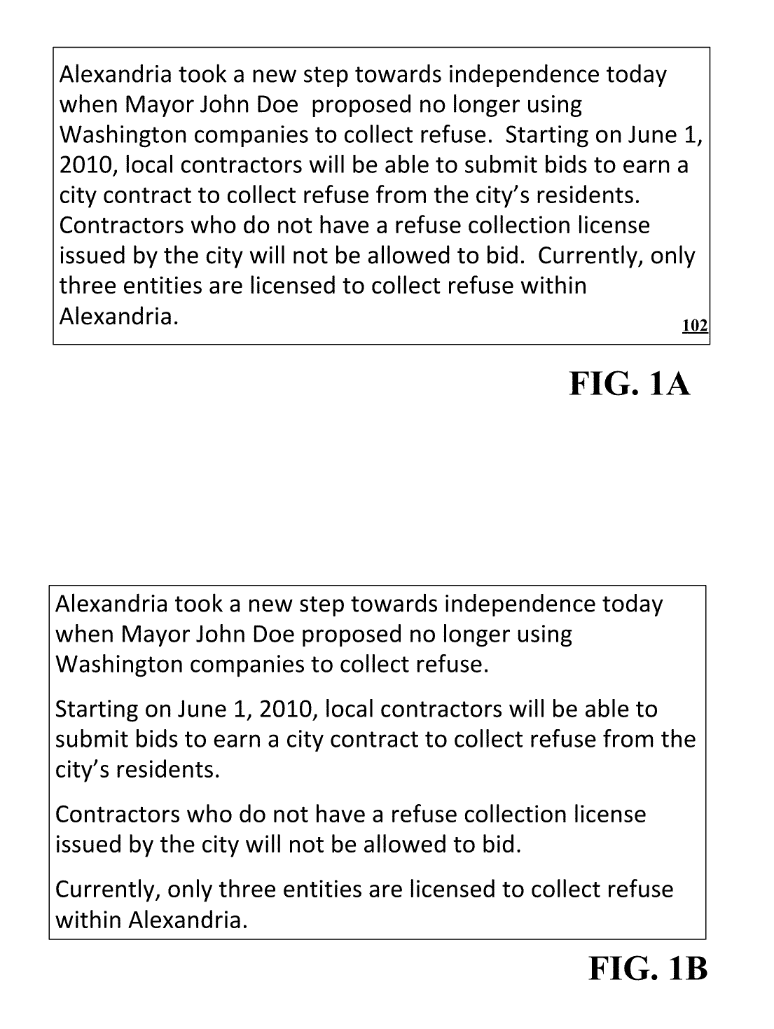

Referring now to FIG. 1A, there is illustrated example content. Block 102 denotes the at least partly textual content, in this example, a news article regarding a mayoral proposal. A news article is just one example of the type of at least partly textual content capable of being auto-annotated. For example, at least partly textual content could include: a research article with associated references, a description of associated video and audio content, aggregated product reviews, etc. Essentially, any content that is partly textual or includes a partly textual description is capable of being analyzed.

FIG. 1B illustrates example content after the first stage of tokenization. In the first stage of tokenization, original text can be divided into sentences. In this figure, the text in block 102 from FIG. 1A has been broken into sentences. In the example, four sentences have been separated into a set of sentences.

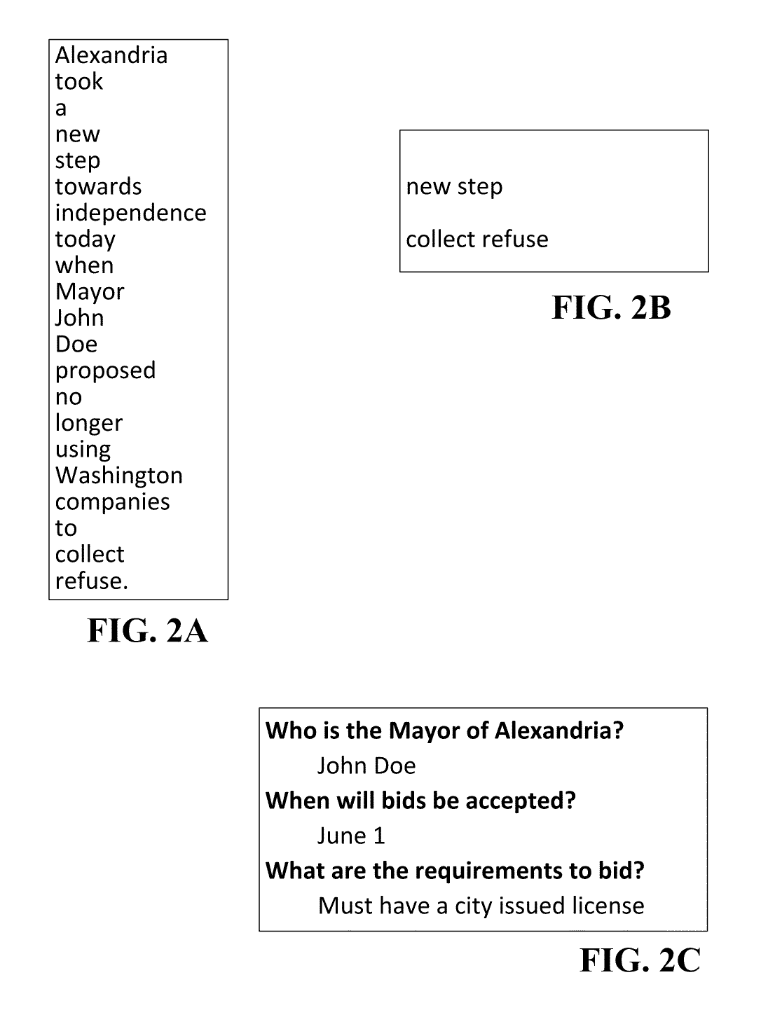

FIG. 2A illustrates example content after the second stage of tokenization. The second stage of tokenization divides the set of sentences into a set of words. For example, as depicted in FIG. 2A, the first sentence in the set of sentences from FIG. 1B has been separated into words. In this example, the sentence is comprised of twenty one words.

Morphological features can then be identified for each word in the set of words. Morphological features can include a part of speech, a gender, a case, a number, a date or a proper noun. For example, starting with the first word in the set of words, Alexandria can be identified as a noun that is capitalized. As “Alexandria” is the first word in the sentence, it is unclear during morphological analysis whether it is a proper noun or merely the first word in a sentence that is capitalized. Morphological analysis can proceed with every word in FIG. 2A. Some words can be multiple types of part of speech. For example, the word “new” can be either an adjective or a noun. Similarly, the word “refuse” can be either a verb or a noun. During morphological analysis, words with multiple possible “part of speech” delineations can be identified for further analysis during a parsing phase.

It can be appreciated that during a morphological analysis, a word dictionary, a phrase dictionary, a person data store, a company data store, or a location data store can be used in determining morphological features associated with a word. For example, the word “Alexandria” can be identified as both a name and a location, for example, Alexandria, Va. or Alexandria, Egypt.

FIG. 2B illustrates an example of parsing. Parsing can define subgroups of related words in a sentence. For example, adjective-verb or noun-verb combinations can be identified. The establishment of these subgroups can help determine ambiguities in morphological analysis. For example, the subgroup “new step” can assist in determining that “new” is used as an adjective, not a noun, as “step” would have an incorrect verb tense to modify “new” if “new” was a noun. In another example, the subgroup “collect refuse” can be identified. “Refuse” can be identified in morphological analysis as either a verb or a noun. Using parsing, the subgroup “collect refuse” can be identified as a verb-noun combination identifying that “refuse” as used in the sentence is a noun and not a verb. Parsing can provide additional insights that morphological feature analysis did not provide, allowing for morphological features to be updated after the parsing stage with the additional information learned.

Semantic analysis can follow parsing, and can be based off updated morphological features associated with the sets of words and sets of sentences. Semantic analysis provides for construction grade wood ties of words within a sentence, identifying the words and/or phrases necessary for “meaning.” In effect, semantic analysis is the extraction of meaning from the text. Using the set of words identified in FIG. 2A, key noun and verbs can be identified from the set of words that allow for meaning to be conveyed using a smaller set of words. For example, “Alexandria Mayor proposed new companies collect refuse” can convey similar meaning in six words as the original sentence did in twenty one words. In constructing meaning, the text can be searched for words, such as “Mayor”, on the basis of which a tree of relationships can be built from. Additionally, numbers signifying dates can be isolated, and predicate rules described in the OWL language can be used in conjunction with the morphological features.

Referring now to FIG. 2C, there is illustrated an example of an auto generated FAQ based on the block 102 from FIG. 1A. In the original text, seventy six words and four sentences were used to introduce the Mayor's proposal. A FAQ can be generated from any extracted meaning. For example, through meaning extraction, it can be learned that John Doe is the mayor of Alexandria, bids will be accepted on June 1, and that a city issued license is a requirement to bid. Questions can be crafted based on the extracted meaning as shown in FIG. 2C, to provide answers to questions related to the text rather than displaying the entirety of the text.

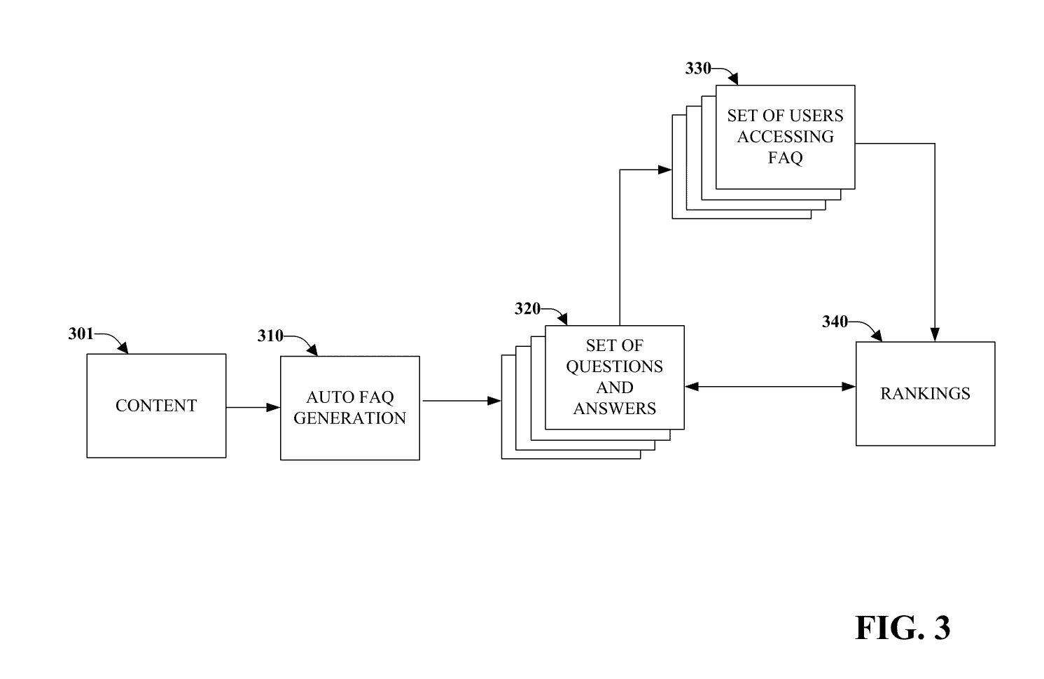

Referring now to FIG. 3, there is illustrated an example high level flow diagram FAQ generation. At 310, Auto FAQ generation can occur based on content 301. Content 301 can include at least partly textual content. The FAQ generated can contain a set of questions and answers 320. A set of users accessing the FAQ 330 can select questions from the set of question, which can be used to update rankings 340. The set of questions and answers 320 can be continuously updated with the rankings 340, whereby a new user accessing the FAQ can have questions sorted by the current rank.

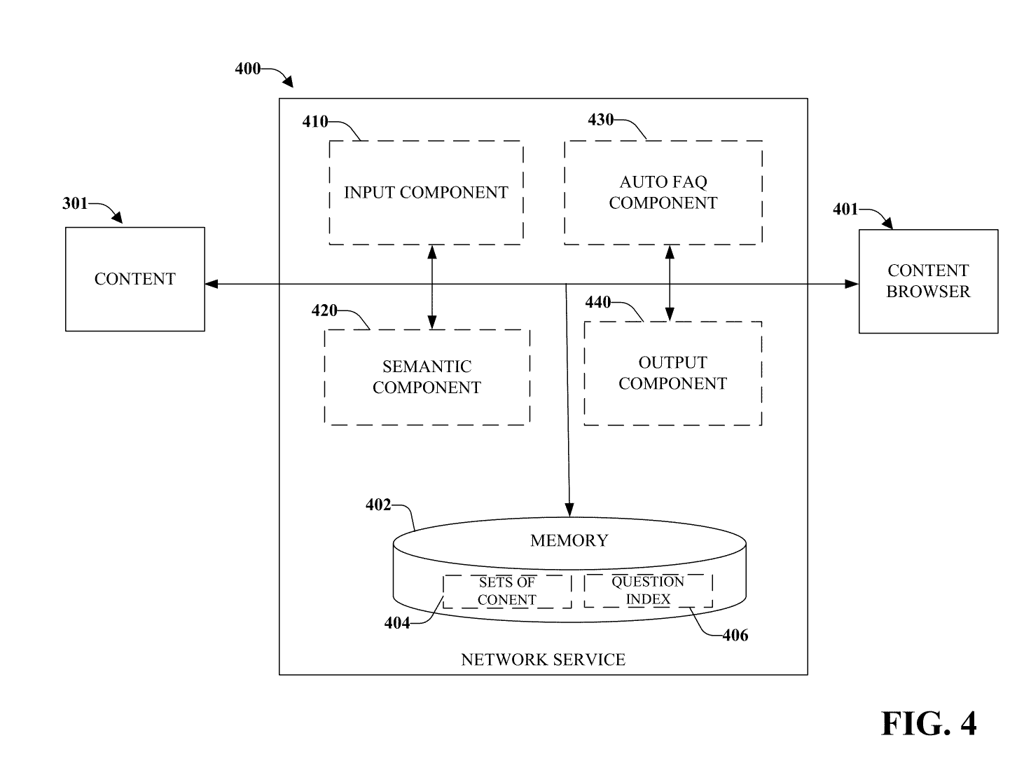

Referring now to FIG. 4, there is illustrated an example network service 400. An input component 410 can receive content 301, wherein the content 301 is at least partly textual. Content can include any information accessible in the network by network service 400 including Internet hosted information. For example, content can be a movie synopsis, a research paper, a news story, a description, etc. A semantic component 420 can, in response to reception of the content, extract meaning from the content.

An auto FAQ component 430 can generate a set of FAQs wherein the set of FAQs contain a set of questions and associated answers. Sets of content 404 can be stored within memory 402 for access by components of network service 400. Output component, 440 can send the FAQ to a content browser 401 for display. Content browser 401 can include an internet browser, a word processing program, a text reader, an image browser, etc.

In one embodiment, output component 440 can further send a question index 406 based on the set of questions to the content browser. Questions of the question index can be selectable for display within the content browser. For example, the question index can list all questions associated with the content allowing the user to see the question index prior to selecting the question in which they desire to read/see an answer. Questions index 406 can be stored within memory 402 for access by component of network service 400.

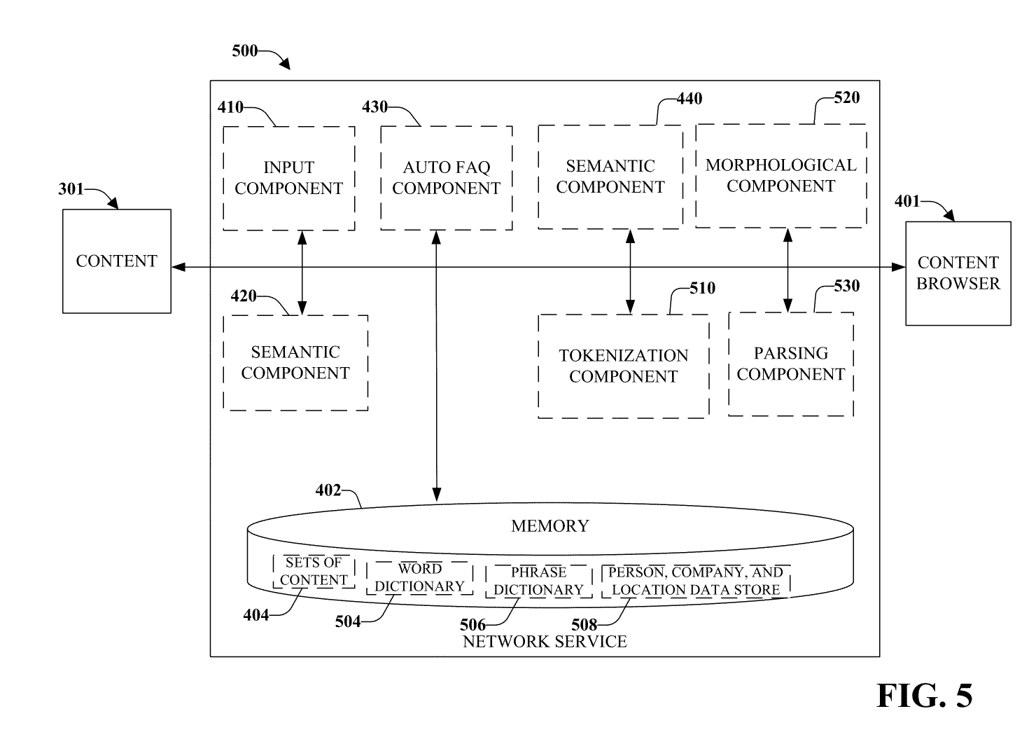

Referring now to FIG. 5, there is illustrated an example network service 500 including components to extract meaning from the textual content. Tokenization component 510 can divide textual content into a set of sentences. Tokenization component 510 can further divide sentences among the set of sentences into sets of words.

Morphological component 520 can identify morphological features for each word in the set of words. Morphological features can include a part of speech, a gender, a case, a number, a date, a proper noun, etc. Morphological component 520 can use word dictionary 504, phrase dictionary 506, and person, company and location data store 508 stored within memory 402 in identifying morphological features. It can be appreciated that separate word dictionaries, phrase dictionaries, and person, company, and location data stores can exist for different languages.

Parsing component 530 can determine, for the words in the set of words, a set of related words based on the morphological features. For example, if the morphological features associated with a word note more than one possibility for a part of speech the word could be belong to; parsing component can link the ambiguous word with neighboring words to form a set of related words. In one embodiment, morphological component 520 can further update morphological features associated with words among a set of words based on the set of related words among the set of words. For example, noting a noun-verb combination can help identify whether a word with ambiguous morphological features is actual a noun or an adjective.

Semantic component 540 can extract meaning from the content further based on the morphological features. For example, a tree can formed based on word relationship to better understand the meaning of all words within the tree. Words near the top of the tree can be given more importance and hence inclusion within annotated text.

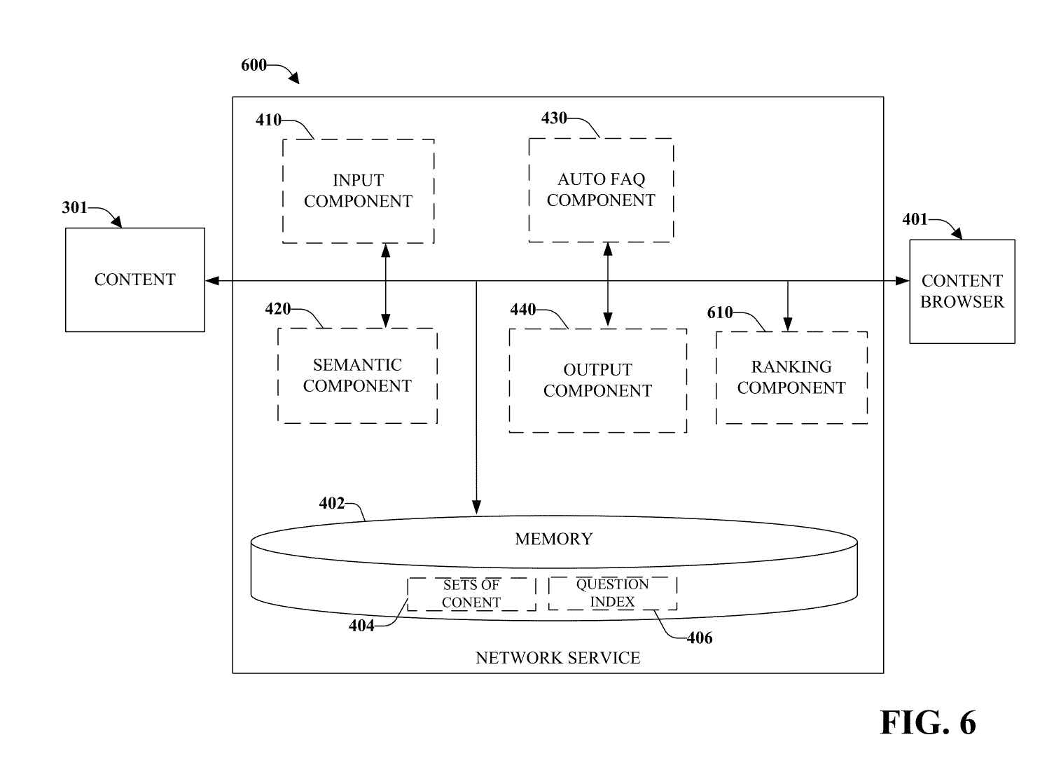

Referring now to FIG. 6, there is illustrated an example network service 600 including a ranking component 610. Ranking component 610 can generate and associate a rank for questions of the set of questions based on at least one of user selections, user reviews, user likes or user dislikes. For example, after each question, a poll can be conducted where a user either “likes” or “dislikes” and answer. A question with the highest like percentage can be ranked higher than those with lower like percentages, where a like percentage is the total number of likes divided by the total number of like and dislikes. A user selecting question to view an answer off the question index can increase the rank associated with a question. Users can be invited to leave a review for a question, which can affect rank. It can be appreciated that any collectable user data associated with accessing or reviewing specific questions and answers can be used to rank questions.

In one embodiment, the question index can be sorted by the rank associated with questions of the question index. For example, those questions that are ranked higher can appear at the top of the question index, or another prominent place on the question index, and questions that are ranked higher are likely more objectively valuable to the typical reader.

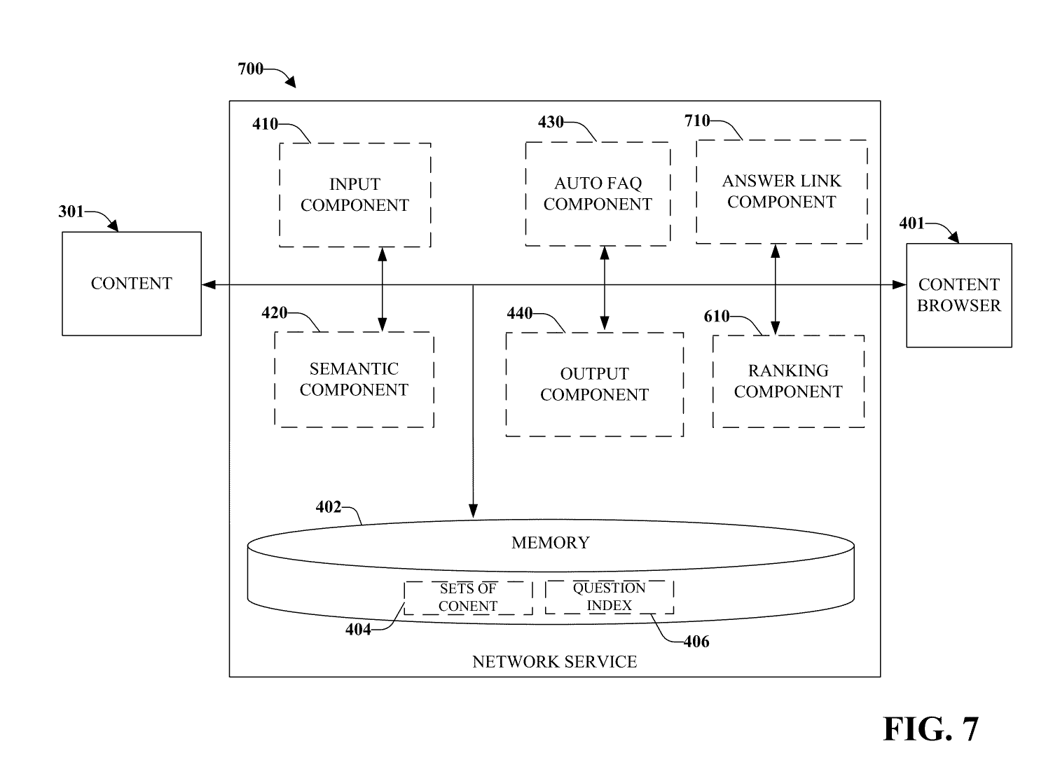

Referring now to FIG. 7, there is illustrated an example network service 700 including an answer link component 710. Answer link component 710 can generate a link for questions within the set of FAQs wherein the link is pointed to a set of sections of the at least partly textual content where the answer was derived from. For example, if the content is long research paper, and a question in the set of FAQs is derived from a section in the middle of that paper, answer link component 710 can generate a link, where when selected, will take the user to the actual part of the content where the answer was derived from. It can be appreciated that the full content may provide context to the answer giving the user additional information not detailed in the set of FAQs.

In one embodiment, answer link component 710 can further highlight the set of sections of the at least partly textual content where the answer was derived from. For example, if multiple sections of the content contributed to the answer in the set of FAQs relating to a question, those multiple sections of the content can be highlighted in some manner that is easily identifiable to a user of the content browser viewing the content.

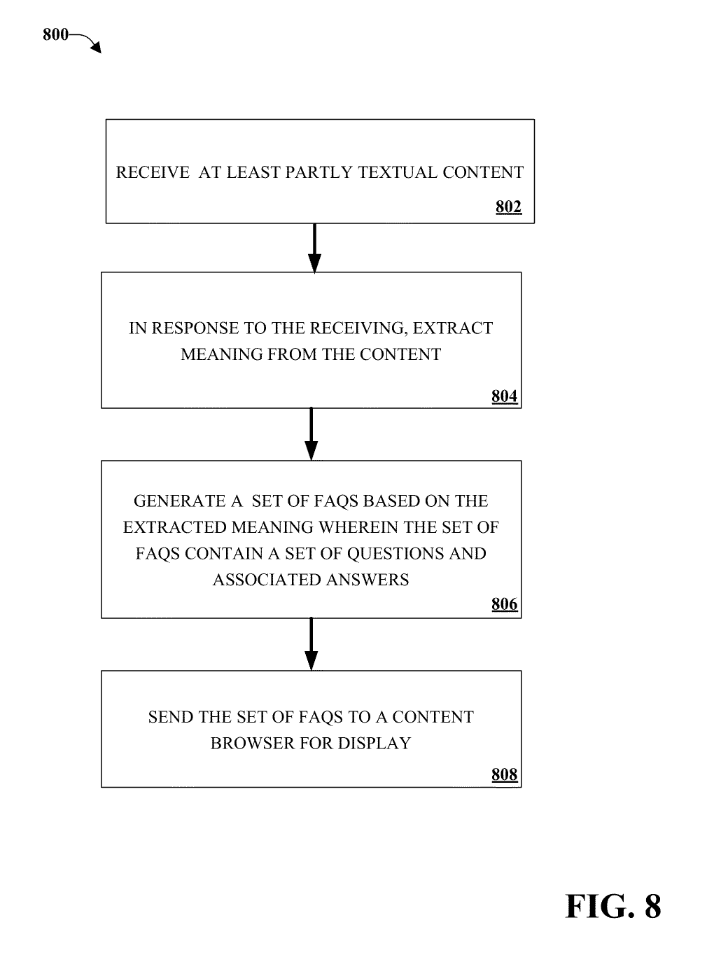

FIGS. 8-11 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 8, there is illustrated an example flow diagram method for auto generation of an FAQ. At 802, at least partly textual content can be received (e.g., by an input component). At 804, in response to the receiving, meaning can be extracted (e.g., by a semantic component) from the content. At 806, a set of FAQs can be generated (e.g., by an auto FAQ component) based on the extracted meaning wherein the set of FAQs contain a set of questions and associated answers. At 808, the set of FAQs can be sent (e.g., by an output component) to a content browser for display.

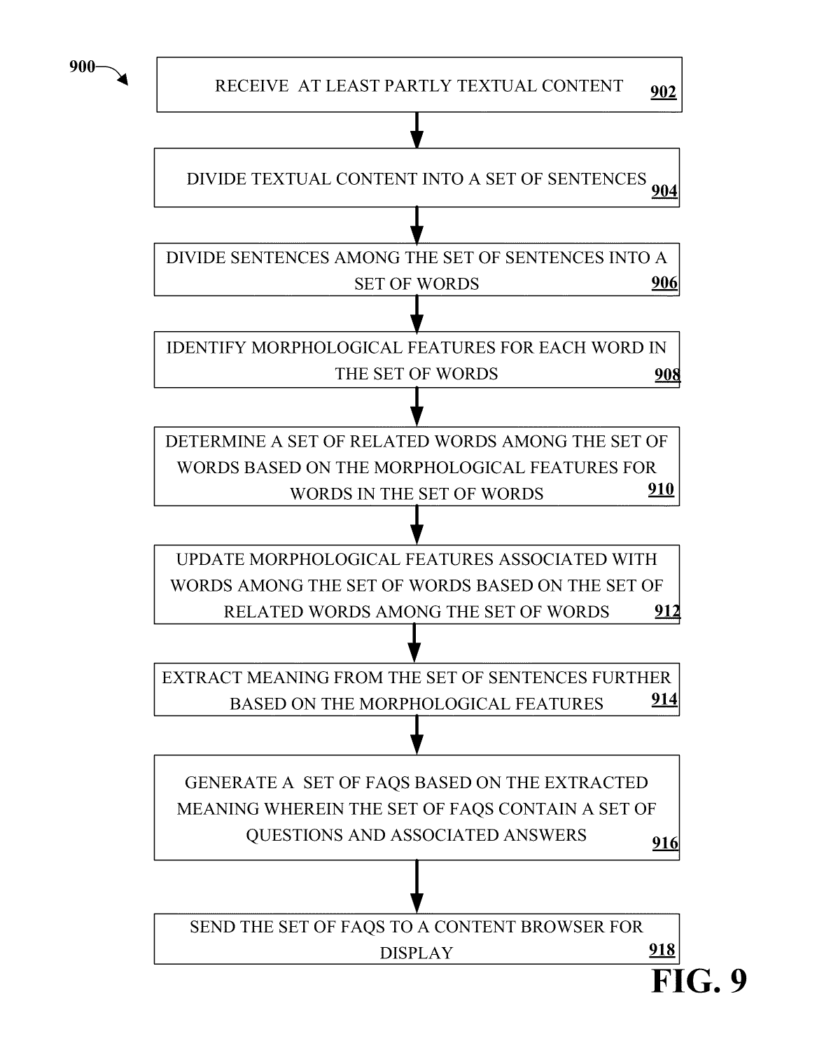

Referring now to FIG. 9, there is illustrated an example flow diagram method for auto generation of an FAQ further based on extracted meaning of the content. At 902, at least partly textual content can be received (e.g., by an input component). At 904, the at least partly textual content can be divided (e.g., by a tokenization component) into a set of sentences. At 906, the set of sentenced can be divided (e.g., by a tokenization component) into sets of words. At 908, morphological features can be identified (e.g., by a morphological component) for words in the set of words. At 910, a set of related words can be determined (e.g., by a parsing component) for words among the set of words based on the morphological features for words in the set of words. At 912, morphological features associated with words among the set of words can be updated (e.g., by a morphological component) based on the set of related words among the set of words. At 914, meaning can be extracted (e.g., by a semantic component) from the set of sentences further based on the morphological features.

At 916, in response to the receiving, a set of FAQs can be generated (e.g., by an auto FAQ component) based on the extracted meaning, wherein the set of FAQs contain a set of questions and associated answers. At 918, the set of FAQs can be sent (e.g., by an output component) to a content browser for display.

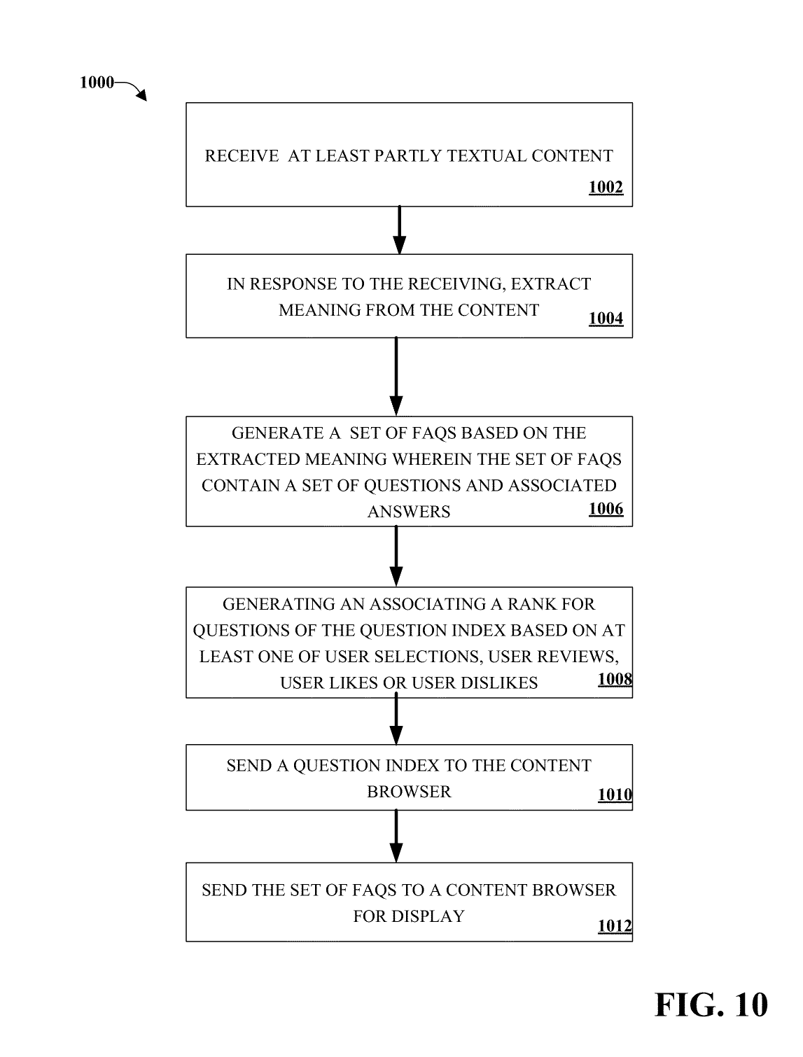

Referring now to FIG. 10, there is illustrated an example flow diagram method for auto generation of an FAQ including rankings. At 1002, at least partly textual content can be received (e.g., by an input component). At 1004, in response to the receiving, meaning can be extracted (e.g., by a semantic component) from the content. At 1006, a set of FAQs can be generated (e.g., by an auto FAQ component) based on the extracted meaning wherein the set of FAQs contain a set of questions and associated answers. At 1008, a rank can be generated and associated (e.g., by a ranking component) for questions of the question index based on at least one of user selections, user reviews, user likes, or user dislikes. At 1010, a question index can be sent to the content browser, wherein the question index can be sorted by the rank associated with questions of the question index. In one embodiment, questions of the question index are selectable for display within the content browser. At 1012, the set of FAQs can be sent (e.g., by an output component) to the content browser for display.

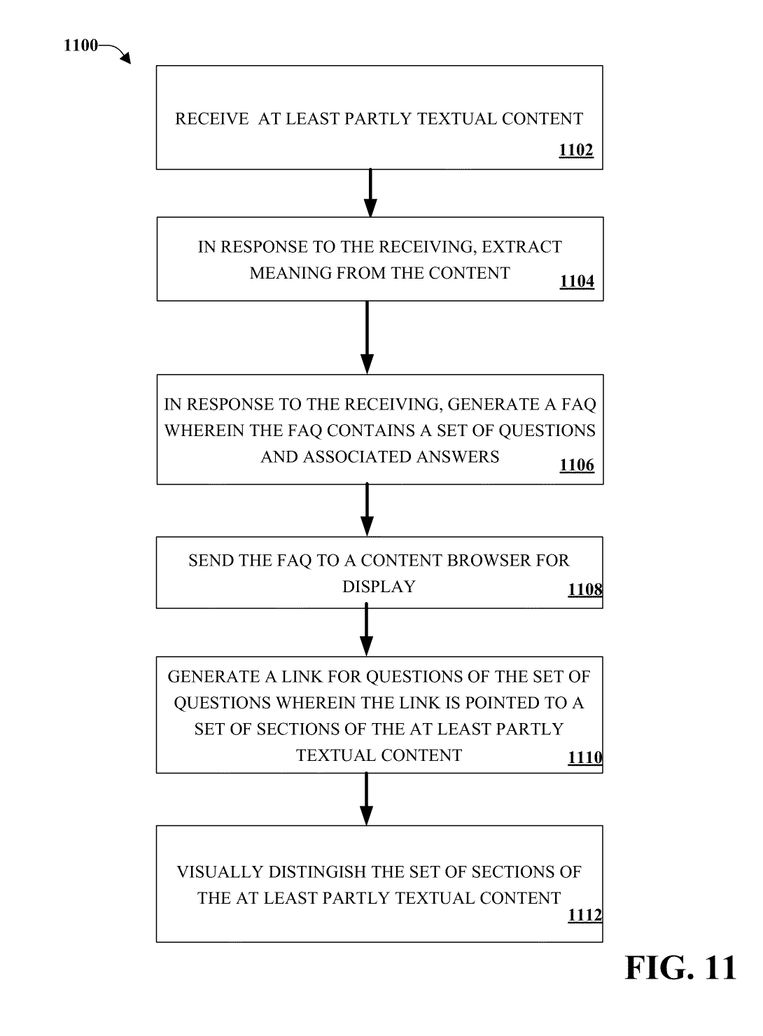

Referring now to FIG. 11, there is illustrated an example flow diagram method for auto generation of an FAQ including linking to content containing answers. At 1102, at least partly textual content can be received (e.g., by an input component). At 1104, in response to the receiving, meaning can be extracted (e.g., by a semantic component) from the content. At 1106, a set of FAQs can be generated (e.g., by an auto FAQ component) based on the extracted meaning wherein the set of FAQs contain a set of questions and associated answers. At 1108, the set of FAQs can be sent (e.g., by an output component) to a content browser for display. At 1110, a link can be generated (e.g., by an answer link component) for questions of the set of questions wherein the link is pointed to a set of sections of the at least partly textual content. At 1112, the set of section of the at least partly textual content can be visually distinguished (e.g., by an answer link component).

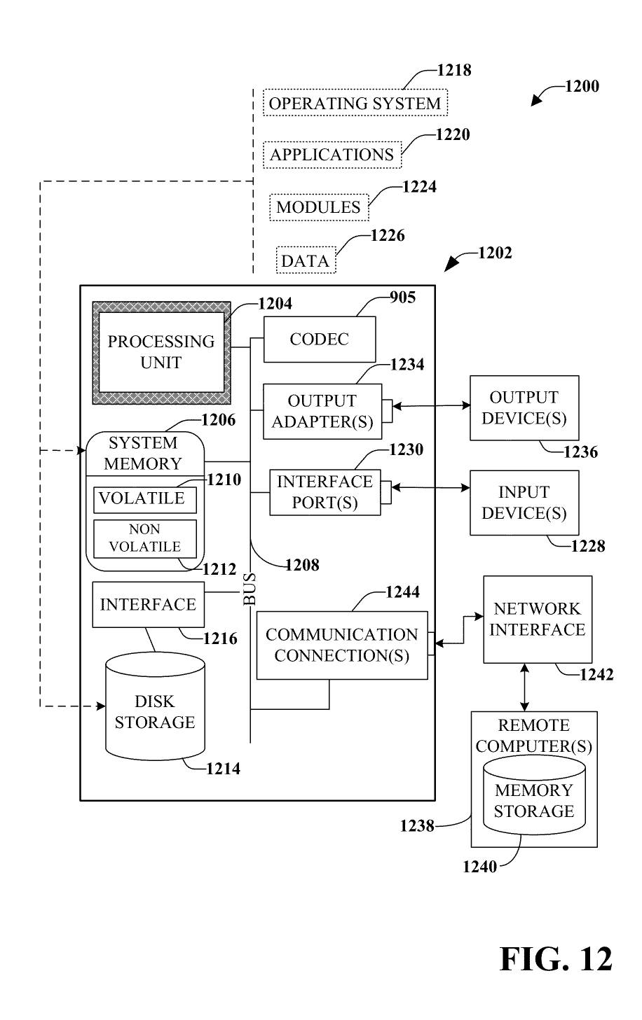

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1202 may also include removable/non-removable, volatile/non-volatile computer storage media. FIG. 12 illustrates, for example, a disk storage 1214. Disk storage 1214 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1214 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s) 1228. Thus, for example, a USB port may be used to provide input to computer 1202, and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

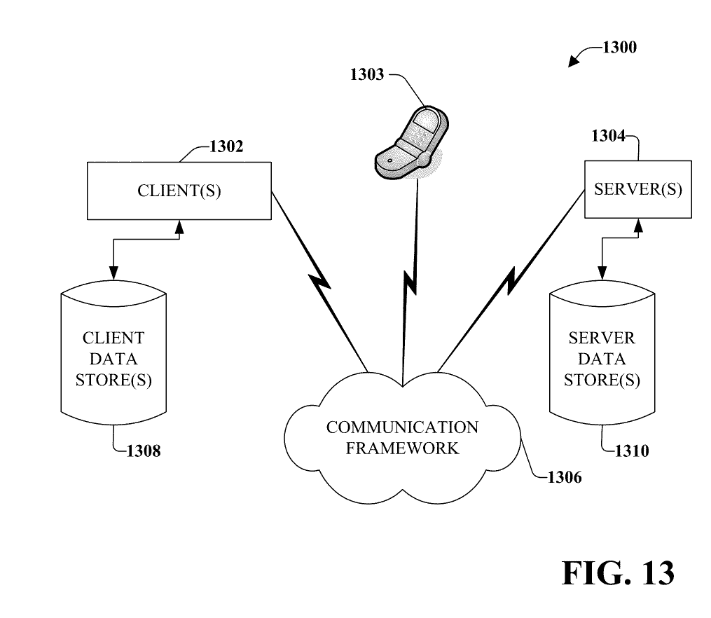

Referring now to FIG. 13, there is illustrated a schematic block diagram of a computing environment 1300 in accordance with the subject specification. The system 1300 includes one or more client(s) 1302, which can include an application or a system that accesses a service on the server 1304. The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware or hardware in combination with software (e.g., threads, processes, computing devices). The servers 1304 can house threads to perform, for example, identifying morphological features, extracting meaning, auto generating FAQs, ranking, etc. One possible communication between a client 1302 and a server 1304 can be in the form of a data packet adapted to be transmitted between two or more computer processes where the data packet contains, for example, a certificate. The data packet can include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A network service, comprising:
a memory that stores computer executable components; and
a processor that facilitates execution of computer executable components stored in the memory, the computer executable components comprising:
an input component that receives content, wherein the content is at least partly textual content;
a semantic component that extracts meaning from the content;
an auto frequently asked question (FAQ) component that generates a set of FAQs in response to reception of the content based on the extracted meaning wherein the set of FAQs contains a set of questions and associated answers; and
an output component that sends the set of FAQs to a content browser for display.

2. The network service of claim 1, wherein the computer executable components further comprise:
a tokenization component that divides the textual content into a set of sentences and divides the set of sentences into respective sets of words.

3. The network service of claim 2, wherein the computer executable components further comprise:
a morphological component that identifies morphological features for words in a set of words of the respective sets of words, wherein the auto annotation component generates differing sets of the content based on the morphological features.

4. The network service of claim 3, the computer executable components further comprising:
a parsing component that determines, for the words in the set of words, a set of related words among the set of words based on the morphological features.

5. The network service of claim 4, wherein the morphological component updates the morphological features associated with the words of the set of words based on the set of related words.

6. The network service of claim 5, wherein the semantic component extracts meaning from the content based on extracting meaning from a sentence of the set of words based on the morphological features.

7. The network service of claim 1, wherein the output component further sends a question index based on the set of questions to the content browser.

8. The network service of claim 7, wherein questions indexed by the question index are selectable for display within the content browser.

9. The network service of claim 7, further comprising:
a ranking component that generates and associates a rank for questions of the set of questions based on at least one of a user selection, a user review, a user like or a user dislike.

10. The network service of claim 9, wherein the question index is sorted by the rank associated with questions indexed by the question index.

11. The network service of claim 1, further comprising:
an answer link component that generates a link for a question of the set of questions within the set of FAQs, wherein the link is associated with at least one section of the textual content from where the answer was derived.

12. The network service of claim 11, wherein the answer link component adds visually distinguishing information to the at least one section to distinguish the at least one section from sections that do not contribute to derivation of the answer.

13. A method, comprising:
receiving, by at least one computing device including at least one processor, at least partly textual content;
in response to the receiving, extracting meaning from the content;
generating a set of frequently asked questions (FAQs) based on the extracted meaning wherein the set of FAQs contains a set of questions and associated answers; and
sending the set of FAQs to a content browser for display.

14. The method of claim 13, further comprising:
dividing the textual content into a set of sentences;
dividing sentences among the set of sentences into a set of words; and
identifying morphological features for words in the set of words.

15. The method of claim 14, further comprising:
determining a set of related words among the set of words based on the morphological features for words in the set of words;
updating the morphological features associated with the words among the set of words based on the set of related words among the set of words wherein extracting meaning from the content is further based on the morphological features.

16. The method of claim 15, further comprising:
sending a question index to the content browser.

17. The method of claim 16, wherein questions of the question index are selectable for display within the content browser.

18. The method of claim 17, further comprising
generating and associating a rank for questions of the question index based on at least one of user selections, user reviews, user likes or user dislikes.

19. The method of claim 18, wherein the question index is sorted by the rank associated with questions of the question index.

20. The method of claim 13, further comprising:
generating a link for questions of the set of questions wherein the link is pointed to a set of sections of the at least partly textual content.

21. The method of claim 20, further comprising:
visually distinguishing the set of sections of the at least partly textual content.

22. A computer-readable storage medium comprising computer-executable instructions that, in response to execution, cause a computing system to perform operations, comprising:
receiving content including receiving textual content of the content;
in response to the receiving, generating a set of frequently asked questions (FAQs) of the content;
sorting the set of FAQs based on a question rank; and
sending the sorted set of FAQs to a content browser.

23. The computer-readable storage medium of claim 22, further comprising:
dividing the textual content into a set of sentences;
dividing sentences among the set of sentences into a set of words; and
identifying morphological features for words in the set of words.

24. The computer-readable storage medium of claim 23, further comprising:
determining a set of related words among the set of words based on the morphological features for words in the set of words;
updating the morphological features associated with the words among the set of words based on the set of related words among the set of words; and
extracting meaning from the set of sentences based on the morphological features wherein the generating the set of FAQs is further based on the extracted meaning.

25. The computer-readable storage medium of claim 22, further comprising:
generating a link for questions of the set of FAQs wherein the link is pointed to a set of sections of the at least partly textual content.

26. A system comprising:
means for receiving, by at least one computing device including at least one processor, at least partly textual content;
means for in response to the receiving, extracting meaning from the content;
means for generating a set of frequently asked questions (FAQs) based on the extracted meaning wherein the set of FAQs contains a set of questions and associated answers; and
means for sending the set of FAQs to a content browser for display.

27. The system of claim 26, further comprising:
means for dividing the textual content into a set of sentences;
means for dividing sentences among the set of sentences into a set of words; and
means for identifying morphological features for words in the set of words.

28. The system of claim 27 further comprising:
means for determining a set of related words among the set of words based on the morphological features for words in the set of words;
means for updating the morphological features associated with the words among the set of words based on the set of related words among the set of words wherein extracting meaning is further based on the morphological features.

29. The system of claim 26, further comprising:
means for generating a link for questions of the set of questions wherein the link is pointed to a set of sections of the at least partly textual content.

30. The system of claim 29, further comprising:
visually distinguishing the set of sections of the at least partly textual content.
